(19) United States
(12) Patent Application Publication
(10) Pub. No.: US 2023/0403147 A1
(43) Pub. Date: Dec. 14, 2023

(54) METHODS AND SYSTEMS FOR VERIFICATION METHOD TO VALIDATE DOCUMENTS

(71) Applicant: Mohammed Alawi E GEOFFREY, Jeddah (SA)

(72) Inventor: Mohammed Alawi E GEOFFREY, Jeddah (SA)

(21) Appl. No.: 18/250,231

(22) PCT Filed: Aug. 4, 2021
(86) PCT No.: PCT/SA2021/050012

§ 371 Date: Apr. 24, 2023

(30) Foreign Application Priority Data
Aug. 3, 2021 (WO) PCT/SA2021/210714

(51) Int. Cl. H04L 9/08; H04L 9/30; H04L 9/32

(52) U.S. Cl. CPC H04L 9/088; H04L 9/30; H04L 9/3247

(57) ABSTRACT

A verification process is provided to provide the user with undoubtful evidence that a remote computer-implemented system in a destination network to perform operations including: reviewing and signing documents using an internet browser and user computer; downloading the sealed document to user computer to review; signing the downloaded sealed document; downloading the digitally signed and sealed document to user computer; and comparing the sealed document timestamp with signed sealed document seal timestamp.

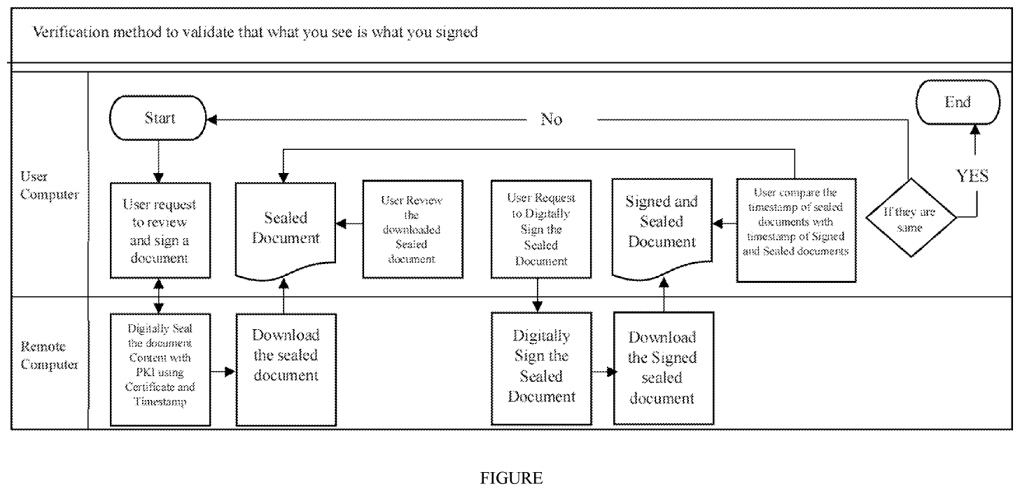

### CROSS REFERENCE TO THE RELATED APPLICATIONS

This application is the national phase entry of International Application No. PCT/SA2021/050012, filed on Aug. 4, 2021, which is based upon and claims priority to International Application No. PCT/SA2021/210714, filed on Aug. 3, 2021, the entire contents of which are incorporated herein by reference.

### TECHNICAL FIELD

A verification process to provide the user with undoubtful evidence that a remote computer has or has not changed a document content during the digital signing process remotely.

### BACKGROUND

Remote Digital Signing using PKI is demanded to sign and adds the digital signature to a document remotely. The user computer is connected to Internet. With a browser he can request a remote computer to review and sign a document in the remote Computer. The user reviews the document content then request the remote computer to digitally sign the document if he approves the document content. The user cannot verify that the remote computer changed the reviewed document after adding his/her signature to the document.

This caused the user not to have trust and assurance each time the user sign using a remote computer. This may cause the user to repudiate by saying that he did not sign what he reviewed. The continuing evolution of the methods of commerce is evident in the increasing replacement of paper-based communications with electronic communications. When communication is by electronically reproduced messages such as e-mail, facsimile machine, imaging, electronic data interchange or electronic fund transfer, however, there no longer exists a signature or seal to authenticate the identity of a party to a deal or transaction. The traditional legally accepted methods of verifying the identity of a document's originator, such as physical presence or appearance, a blue-ink signature, personal witness or Notary Public acknowledgment, are not possible.

U.S. Pat. No. 5,724,425 discloses the use of public key encryption, and more particularly, the present invention relates to the use of public key encryption to achieve enhanced security and product authentication in the distribution of software.

Techniques of authentication vary in their ease of use and their reliability. For instance, a classical authentication technique in both electronic and non-electronic systems is the password. Anyone who knows the password for the club is assumed to be a member and is admitted. Anyone who doesn't know the password is prohibited. Similarly, someone who knows a particular individual's password is assumed to be that individual, while someone who doesn't is assumed to be someone else.

This technique is fairly simple to implement, and fairly simple to use. The individuals being authenticated need merely remember the password, and they can be authenticated by anyone else who knows the password. However, such a technique is also fairly unreliable; people may be forget their own password or overhear someone else's password.

Other techniques for authentication involve the use or control of a particular token, such as a particular key, either physical or electronic. Still other techniques are based upon some immutable physical characteristic of a user, such as a fingerprint or the sound of their voice. Some of these techniques are more reliable than others. For instance, fingerprints are more effective authenticators than passwords in most cases. However, analyzing a fingerprint to determine if someone is who they claim to be is much more complex than simply comparing passwords. Generally, the more reliable a technique of authentication is, the more cumbersome it is to use.

U.S. Pat. No. 7,260,724 discloses cryptographic authentication. More specifically, the present invention relates to the evaluation of an authentication event based upon the context of that event.

Accordingly, it is necessary to find systems and methods for providing a verifiable chain of evidence and security for the transfer and retrieval of documents and other information objects in digital formats.

### SUMMARY

In the first embodiment, the present invention provides a non-transitory, computer-readable medium storing computer-readable instructions executable by a remote computer-implemented system in a destination network to perform operations including: reviewing and signing documents using an internet browser and user computer; downloading the sealed document to user computer to review; signing the downloaded sealed document; downloading the digitally signed and sealed document to user computer; and comparing the sealed document timestamp with signed sealed document seal timestamp.

Another aspect of the invention provides the remote computer seals the document using PKI with a certificate and timestamp.

Another aspect of the invention provides the remote computer including a document and data repository configured to securely store personal data for at least one user, wherein the secured personal data for each specific user is stored in a datastore associated with the specific user.

Another aspect of the invention provides the non-transitory, computer-readable medium includes a key trust configured to generate at least one cryptographic key pair for the at least one user, to store a first cryptographic key of the at least one cryptographic key pair and to export a second cryptographic key of the at least one cryptographic key pair from the key trust.

Another aspect of the invention provides the non-transitory, computer-readable medium includes a biometric database configured to provide a storage location for at least one biometric captured from and associated with the at least one user, wherein the biometric is captured during enrollment in the electronic data vault system.

Another aspect of the invention provides the non-transitory, computer-readable medium includes an interface configured to allow controlled access to the remote server by at least one user and to allow for transmission of the at least one captured user biometric to the system.

Another aspect of the invention provides the non-transitory, computer-readable medium if timestamps are same in both documents, the remote computer keeps the downloaded sealed document during digital signing, and in case of contrary, the remote computer changes the downloaded sealed document during digital signing.

Another aspect of the invention provides a system in a destination network reviewing and signing documents, including:
means for reviewing and signing document for signing using an internet browser and user computer;
means for downloading the sealed document to user computer to review;
means for signing the downloaded sealed document;
means for downloading the digitally signed and sealed document to user computer; and
means for comparing the sealed document timestamp with signed sealed document seal timestamp.

### BRIEF DESCRIPTION OF THE DRAWINGS

The present invention is described in more detail below in connection with the attached drawings, which are meant to illustrate and not to limit the invention, and in which:

The FIGURE illustrates a block diagram of a cryptographic system according to aspects of an embodiment of the invention;

### DETAILED DESCRIPTION OF THE EMBODIMENTS

The solution includes of user computer connected to internet and a remote computer connected to the internet. The user computer sends a request to the Remote computer to review and sign a document using PKI with CA issued certificate and a timestamp. The remote computer digitally seals the document using PKI with CA issued certificate and a timestamp for authenticity proof to guarantee the integrity of the document then downloads the sealed document to the user computer for user to review the downloaded sealed document. before user signs the document for content approval. After the user review the sealed document and agrees on the term, the remote computer signs the document and downloads the signed and sealed document to user computer.

The user can verify by comparing the downloaded sealed documents seal timestamp with signed and sealed document seal timestamp. If they are the same then remote computer integrity is fine otherwise the integrity is not ok and user need to inform technical support of the remote computer.

What is claimed is:

1. A non-transitory, computer-readable medium storing computer-readable instructions executable by a remote computer-implemented system in a destination network to perform operations comprising:
reviewing and signing documents using an internet browser and a user computer;
downloading a sealed document to the user computer to review;
signing the sealed document;
downloading a digitally signed and sealed document to the user computer; and
comparing a sealed document timestamp with a signed sealed document seal timestamp.

2. The non-transitory, computer-readable medium according to claim 1, wherein a remote computer seals the document using PKI with a certificate and timestamp.

3. The non-transitory, computer-readable medium according to claim 1, wherein a remote computer comprises a document and data repository configured to securely store personal data for at least one user, wherein the personal data for each specific user is stored in a datastore associated with the specific user.

4. The non-transitory, computer-readable medium according to claim 1, further comprising a key trust configured to generate at least one cryptographic key pair for at least one user, to store a first cryptographic key of the at least one cryptographic key pair and to export a second cryptographic key of the at least one cryptographic key pair from the key trust.

5. The non-transitory, computer-readable medium according to claim 1, further comprising a biometric database configured to provide a storage location for at least one biometric captured from and associated with at least one user, wherein the at least one biometric is captured during an enrollment in an electronic data vault system.

6. The non-transitory, computer-readable medium according to claim 1, further comprising an interface configured to allow an controlled access to a remote server by at least one user and to allow for a transmission of at least one captured user biometric to the remote computer-implemented system.

7. The non-transitory, computer-readable medium according to claim 1, if timestamps are same in two documents, a remote computer keeps the sealed document during digital signing, and in of contrary, the remote computer changes the sealed document during digital signing.

8. A system in a destination network reviewing and signing documents, comprising: means for reviewing and signing a document for signing using an internet browser and a user computer;
means for downloading a sealed document to the user computer to review;
means for signing the sealed document;
means for downloading a digitally signed and sealed document to the user computer; and
means for comparing a sealed document timestamp with a signed sealed document seal timestamp.
